(19) United States
(12) Patent Application Publication
(10) Pub. No.: US 2004/0175487 A1
(43) Pub. Date: Sep. 9, 2004

(54) High protein and low calorie raw batter for making products, in particular fried products, resembling potato-based products, and method for preparing same

(75) Inventors: Reginald Allouche, Paris (FR); Aurelie Stewart, Kremlin Bicetre (FR)

Correspondence Address: PIPER RUDNICK, P.O. Box 64807, Chicago, IL, 60664-0807, US

(73) Assignee: CEPRODI - Compagnie Europeenne De Produits Dietetiques

(21) Appl. No.: 10/420,200

(22) Filed: Apr. 22, 2003

(30) Foreign Application Priority Data
Mar. 4, 2003 (FR) 03 02630

(51) Int. Cl. A23L 1/216

(52) U.S. Cl. 426/637

(57) ABSTRACT

The subject of the present invention is a food preparation in the form of a raw batter capable of being shaped, in particular into sticks, balls, patties or portions, capable of being directly cooked at the time of consumption by any type of cooking, in particular in a fryer, and allowing the production of products copying or resembling traditional potato-based products such as, for example, chips, dauphine potatoes, deep-fried potato balls, “rosti” potatoes or potato pancakes, the said food preparation having a reduced protein content and a low carbohydrate and lipid content.

The subject of the invention is also the products which are cooked in particular in the presence of fat at high temperature and which are obtained from the said food preparation in the form of a raw batter and shaped.

The subject of the present invention is a food preparation in the form of a raw batter capable of being shaped, in particular into sticks, balls, patties or portions, capable of being cooked directly at the time of consumption by any type of cooking, in particular in a fryer, and which makes it possible to obtain products copying or resembling traditional potato-based products such as, for example, chips, dauphine potatoes, deep-fried potato balls, “rosti” potatoes or potato pancakes, the said food preparation having a reduced protein content and a low carbohydrate and lipid content.

The invention also relates to a food preparation in the form of sticks, balls, patties or portions, which have undergone no cooking or precooking treatment, designed for the preparation, by cooking, especially in a fryer, of products copying or resembling traditional potato-based products, which is obtained by shaping the food preparation in the form of raw batter.

The subject of the invention is also the products cooked especially in the presence of fat at high temperature, which are obtained from the said food preparation in the form of a raw batter and shaped.

The abovementioned potato-based traditional products, in particular fried products, are par excellence products reputed anti-diet and very unbalanced from a nutritional point of view because, even if they do not necessarily initially contain a high lipid content, their preparation necessarily requires precooking or cooking in a, or with the aid of a vegetable or animal fat. That is obviously the case for chips which are cooked in a bath of oil or fat, or potato pancakes which, while they can simply be reheated in a non-stick frying pan, have nevertheless undergone a precooking step in the presence of fat during their preparation.

While it is obvious that consumers are increasingly aware of their physical appearance and do not therefore wish to gain weight, it is also true that they nevertheless wish to continue eating while having fun, that is to say eating tasty products to satiety. They are therefore increasingly led to turn to multiple so-called “slimming” diets, or in any case to less fatty products, which are most generally characterized by a lower daily calorie supply, obtained by a lower quantity of ingested food which is most often associated with a reduction in the lipid content.

Unfortunately, these diets are difficult to observe over a long period because the palatability of the fat often gives a texture and a sensation in the mouth which are very difficult to reproduce, which results in the fact that their absence or their reduced presence causes a characteristic feeling of frustration. In addition, these diets have as a consequence a loss of weight linked to a loss of muscle mass, that is to say a loss of lean mass. A lack of skin tone and elasticity, and a physical and intellectual asthenia are then observed. In addition, people following these diets by the letter do not eat as much as they would wish and therefore suffer from hunger and feel frustrated.

A need therefore exists to have diet products which, while being low in calories, or in any case with a low fat content, do not cause the harmful consequences indicated above and which therefore allow the consumer to follow a diet with pleasure, by allowing him to eat to satiety without increasing his fatty mass as a result, and without this being at the detriment of his lean mass.

It would consequently be desirable to offer the body a higher supply of proteins of high nutritional and biological value, and a lower supply of lipids, through food products reproducing the shape, texture, taste and odour of current food products having a “pleasure” connotation.

The inventor of the present invention has already proposed, in International Patent Application WO 01/89325, a high protein and low calorie raw batter which can be successfully used for the manufacture of products resembling potato-based products, such as chips, dauphine potatoes or potato pancakes. However, as this patent application indicates, the final product should still be prepared directly by the user by cooking the said raw batter exclusively in an oven, in a frying pan or by infrared cooking. Indeed, it has proved impossible to cook the said raw food batter in a fryer, the products not withstanding this type of cooking since they become soft and then disintegrate more or less completely in the bath of fat. Even in the rare cases where it was possible to obtain a fried product which has preserved a degree of integrity of texture, the organoleptic properties of this product were not satisfactory.

The Applicant therefore focused on solving this technical problem and has had the merit of having succeeded in defining and in developing a low calorie and high protein, raw food preparation capable of giving, after cooking in a bath of fat heated to a high temperature, a product having a texture and a taste comparable to traditional products, such as in particular chips.

The said food preparation thus suited to cooking in the presence of fat at high temperature, in particular in a fryer-type apparatus, has, in addition, particular nutritional characteristics which mean that, after cooking, it preserves nutritional characteristics in relation to carbohydrates and lipids lower than fried products for general consumption, and a considerably higher protein content.

It is by virtue of a precise selection of the nature and quantity of the ingredients entering into the composition of this food preparation that the inventor succeeded in satisfying the constraints of a technical, nutritional and organoleptic nature, and of ease of preparation, while responding to the expectations of consumers and of industrialists of being able to have food products which are very similar to the conventional products.

The food preparation in the form of a raw batter, capable of being shaped, in particular into sticks, balls, patties or portions, capable of being directly cooked at the time of consumption by any type of cooking, in particular in a fryer, and allowing the production of products copying or resembling traditional potato-based products, in particular fried products, is characterized in that it has a content of 15 to 30% of potato flakes, a content of 2 to 10% of whole egg powder or of egg white, and a content of 10 to 30% of milk proteins, and an overall protein content of between 10 and 30%, an overall carbohydrate content of between 7 and 30%, an overall lipid content of between 0.5 and 8%, a water content of between 40 and 70%, and a chemical value greater than 100, the said contents being expressed by weight per weight relative to the commercial product.

It is recalled that the expression chemical value of a protein is understood to mean the product by 100 of the smallest of the quotients obtained by dividing, for each of the essential amino acids or groups of essential amino acids, the quantity present in 100 g of this protein by the corresponding quantity present in 100 g of the protein serving as reference, the latter being characterized by the following contents expressed relative to 100 g:

| | | |
|---|---|---|
| L isoleucine | 4 | g |
| L leucine | 7 | g |
| L lysine | 5.5 | g |
| DL methionine + L cystine | 3.5 | g |
| L phenylalanine + L tyrosine | 6 | g |
| L threonine | 4 | g |
| L tryptophan | 1 | g |
| L valine | 5 | g |

It is more particularly by virtue of the presence of a high content of potato flakes, the use of whole egg powder or of egg white, the latter ingredients acting as binding agent, and of the presence of a content of 10 to 30% of milk protein, in particular of total milk protein, that the inventor has succeeded in satisfying all the imposed technical and organoleptic constraints and has thus succeeded in manufacturing products having, after cooking, in particular in a fryer, a texture and a taste which are extremely satisfactory, while having a lower lipid content and a very markedly higher protein content than the traditional products imitated.

The food preparation in the form of a raw batter in accordance with the invention has a total calorific value before cooking of between 140 and 230 kcalories per 100 g, preferably between 140 and 220 kcalories per 100 g, and still more preferably between 140 and 210 kcalories per 100 g.

Preferably, the potato flake content of the said food preparation is between 15 and 29%, and preferably between 15 and 28%.

The milk protein content is, for its part, preferably between 10 and 28%, and still more preferably between 10 and 25%, and the egg powder or egg white content is preferably between 2.5 and 9%, and still more preferably between 2.5 and 8%.

The raw food preparation according to the invention has, moreover, an overall protein content (expressed as N×6.25) preferably of between 10 and 18%, and still more preferably between 12 and 26%, an overall carbohydrate content preferably of between 7 and 28%, still more preferably between 10 and 27%, and a lipid content of between 1 and 8%, still more preferably between 1.5 and 8%.

The milk proteins used in the composition of the food preparation according to the invention essentially consists of total milk protein, that is to say the proteins obtained from skimmed milk by an ultrafiltration process which does not denature these molecules, in particular, for example, the total milk protein marketed by the company TRIBALLAT. It is possible to use other milk proteins such as caseine, caseinates, lactalbumin or whey, but in minimal quantities relative to the total milk protein, this ingredient very markedly influencing the texture and taste of the final products.

As indicated above, the binder will be composed of egg, or egg white, in powdered form or in its natural state. It will be possible to use in particular the products marketed by the companies OVONOR or IGRECA. The binding and emulsifying functionalities of these ingredients are useful in order to solve the technical problems forming the basis of the present invention.

As carbohydrates, it is possible to use any type of starch, of any origin, native or modified, in particular maize starch, potato starch or cassaya starch, but, as indicated above, it is essentially the potato flakes which contribute to the carbohydrate content present in the food preparation in accordance with the invention.

Preferably, the preparation according to the invention may also contain a thickener, preferably chosen from gums and starches, the said thickener being present in a quantity between 0 and 6%, preferably between 0.8 and 6%, and still more preferably between 0.8 and 5.5% of the preparation. Among the gums, it will be possible to choose guar or carob gums, carrageenans, alginates or xanthan gums. As regards the starches, it will be possible to use, for example, pregelatinized or extruded starches.

The water content of the raw food preparation according to the invention is between 40 and 70%, preferably between 42 and 70%, and still more preferably between 45 and 70%.

As lipids, it is preferable to use powders of copra, palm, soyabean or sunflower fat.

Of course, the food preparation in the form of a raw batter in accordance with the invention may also contain other conventional ingredients such as flavourings, amino acids, spices, condiments, taste enhancers, colourings, vitamins, minerals, soluble or insoluble fibres such as in particular inulin or glucose or fructose polymers, leavening powders and intense sweeteners. As regards the flavourings, they are present in a quantity generally between 0 and 4%, preferably between 0.3 and 3.5%, and still more preferably between 0.8 and 3.2%.

It is also possible to add thereto, as necessary, vegetable, meat, fish, cheese or fruit pieces or powder.

Of course, even though the food preparation according to the invention essentially has the advantage of being able to be cooked in a fryer, it can nevertheless be cooked by any other means of cooking, in the presence or in the absence of fat, in particular in a frying pan or in an oven.

The subject of the invention is also the method for making the food preparation in the form of a raw batter in accordance with the invention, this method being characterized in that it comprises the following steps:

selecting the ingredients, weighing and measuring out, the said ingredients being for the majority in powder form,

intimately mixing the said ingredients, with or without premixing,

adding the liquids to the said mixture, with moderate and regular stirring, in particular in a kneader, in order to lead to the formation of a bound and homogeneous batter,

forming,

optionally treating by means of refrigeration or deep-freezing.

The forming step may consist in particular in laminating followed by cutting or forming into individualized portions such as chips, dauphine potatoes, minipatties and the like, or may simply consist in forming into lumps, the latter being directly formed in the home of the final user.

The subject of the invention is also the cooked food product, in the form of sticks, balls, patties or portions, copying or resembling cooked traditional potato-based products, this product being obtained after forming and cooking the food preparations in the form of a raw batter in accordance with the invention.

The cooked food product obtained by cooking in the presence of fat, in a cooking apparatus of the fryer type, is a novel food product since it has a high protein content, a low lipid content, and in that it exhibits good homogeneity, an aerated texture inside and a crisp outer texture. This food product cooked in the presence of fat in a cooking apparatus of the fryer type is in particular characterized in that it has a protein content of 10 to 30%, a carbohydrate content of 10 to 30%, and a lipid content of 9 to 30%, the contents being expressed by weight per weight on the product obtained after cooking. It has most generally a water content of 15 to 50%, preferably 18 to 48%, still more preferably 20 to 48%. Its calorific value is less than that of the traditional products imitated, since it is between 200 and 510, preferably between 210 and 490, and still more preferably between 220 and 490 kcalories per 100 g.

The invention will be understood more clearly with the aid of the examples which follow, which are given purely by way of illustration.

### EXAMPLE 1

A food preparation in the form of a raw batter is prepared according to the teaching of Patent Application WO01/89325. Its formulation is presented in Table 1 below.

TABLE 1

| Ingredients | % by weight |
|---|---|
| Flavouring DF11664 (company QUEST) | 2.73 |
| Sodium bicarbonate | 0.09 |
| Sodium caseinate 220 (company EPI | 22.50 |
| INGREDIENT) | |
| Potato starch PJ30 | 0.45 |
| Inulin RAFTILINE GR (company ARNAUD) | 2.27 |
| Isaguar gum (company DISATEC) | 0.91 |
| L Methionine (company QUIMDIS) | 0.11 |
| Egg powder (company OVONOR) | 3.18 |
| Potato flakes (company BEAUMARAIS) | 9.32 |
| Salt | 1.23 |
| Vana Grassa 80C090 (company ARNAUD) | 1.30 |
| Soya bean proteins 90DS (company LUCAS | 1.36 |
| MEYER) | |
| Water | 54.55 |
| Total protein content | 23.32 |
| Total carbohydrate content | 9.9 |
| Total lipid content | 2.7 |

A homogeneous batter having good textural properties is obtained from this formulation. It has the advantage of leading, after cooking in an oven, to the production of a finished product which is quite similar to a conventional chip on the market to be cooked in the oven, while providing a very high protein content. The kneading capacity is good but it nevertheless remains delicate to carry out. The laminating operation is carried out very satisfactorily, the batter resisting well and stretching sufficiently. The cooking obtained in a traditional oven reveals a homogeneous cooking.

The tasting test carried out on chips thus prepared and cooked in a traditional oven gives fairly eulogistic results, considering how difficult it is to achieve such good nutritional values, the chips being judged by the tasters as having a good taste and a good odour and as having organoleptic properties and an appearance which are very similar to traditional potato chips cooked in an oven. However, from the point of view of the texture, it can be noted that the centre of the product cooked in the oven would benefit from being improved if possible, in order to obtain a texture in the centre which is closer to that of puree.

Several tests were also carried out on this food preparation with a fryer-type cooking. The results obtained are not at all satisfactory, both from the point of view of the texture and of the taste. Indeed, the food preparation prepared according to the invention given in Table 1 disintegrates in hot oil, has no resistance, and the inside of the sticks is not at all similar to that of conventional chips (appearance of puree sought).

Reformulation trials were therefore carried out with the aim of obtaining a texture which is acceptable both from the point of view of the manufacture and preparation of the raw product and from the point of view of the preparation introduced into the fryer.

### EXAMPLE 2

Table 2, below, represents one of the formulations thus modified and tested.

TABLE 2

| Ingredients | % by weight |
|---|---|
| Flavouring DF11664 (company QUEST) | 2.47 |
| Beta-carotene colouring | 0.07 |
| Whey protein (company TRIBALLAT) | 6.46 |
| Potato starch PJ30 | 0.76 |
| Inulin RAFTILINE GR (company ARNAUD) | 1.52 |
| Thickener/gelling agent (company DISATEC) | 0.38 |
| Egg powder (company OVONOR) | 41.52 |
| Potato flakes (company BEAUMARAIS) | 3.8 |
| Salt | 0.95 |
| Vana Grassa 80C090 (company ARNAUD) | 2.66 |
| Total milk protein (company TRIBALLAT) | 13.6 |
| pregelatinized wheat flour | 3.8 |
| Water | 62 |
| Total protein content | 19 |
| Total carbohydrate content | 10 |
| Total lipid content | 3.7 |

The nature of the proteins was modified in favour of the milk and egg protein. It could be expected that, by virtue of the egg proteins in particular, the preparation would be seared by the frying. The presence of a thickener was, on the other hand, maintained in order to confer on the raw batter a degree of homogeneity allowing it to be laminated.

A homogeneous, laminable batter was in fact obtained. However, the cooking in the fryer was not satisfactory: the product still does not have the desired “purée” texture inside the sticks, but rather a gelatinous appearance. The outside of the sticks is not sufficiently crisp either and the taste resembles that of bread.

### EXAMPLE 3

TABLE 3

| Ingredients | % by weight |
|---|---|
| Potato flakes (company BEAUMARAIS) | 24 |
| Salt | 1 |
| Leavening powder | 0.5 |
| Total milk protein (company TRIBALLAT) | 15 |
| Whole egg powder | 4.5 |
| Water | 55 |
| Total protein content on the raw batter | 15.9 |
| Total carbohydrate content on the raw batter | 18 |
| Total lipid content on the raw batter | 2 |
| Total protein content on the fried batter | 15 |
| Total carbohydrate content on the fried | 17 |
| batter | |
| Total lipid content on the fried batter | 15 |

This formula results in a moderate crumbly, relatively well homogenized batter. The latter characteristic could be further improved by virtue of the addition of a thickener as in the abovementioned examples. On the other hand, the reaction of this batter to cooking in a very hot bath of fat is excellent. The sticks are seared on the outside, and the inside indeed has a puree texture. Unlike the trials described above, the batter does not disintegrate. Finally, in the light of the nutritional values, it appears that this batter makes it possible to reduce the absorption of fat.

Sensory analyses were carried out by naive controls, the latter having to taste a succession of chips 20 covered by the present invention (A), compared with samples of commercial “fast food” type chips (B), presented randomly such as for example: A A B B A B B A A B

The testers had to say if the sample presented was different from the preceding one. The test was carried out according to a blind design.

Following this test, a clear difference was observed between the two samples. The next question consisted of a test of preference between A and B.

The results clearly demonstrate a preference for product A. The remarks were generally that A was very similar in taste and texture to the “home made” product.

The possibility is thus available, by virtue of the invention, for making products rich in proteins and low in calories, and which can be cooked in a fryer, having good nutritional values despite cooking in the presence of fat, and a taste and a texture which are acknowledged to be very similar to those of traditional products.

These products can be sold as deep-frozen products, can be easily prepared, and meet the requirements of industrialists of mass distribution outlets and of the fast food industries.

1. Food preparation in the form of a raw batter, capable of being shaped, in particular into sticks, balls, patties or portions, capable of being directly cooked at the time of consumption by any type of cooking, in particular in a fryer, and allowing the production of products copying or resembling traditional potato-based products, having a content of 15 to 30% of potato flakes, a content of 2 to 10% of whole egg powder or of egg white acting as binder, a content of 10 to 30% of milk proteins, and an overall protein content of between 10 and 30%, an overall carbohydrate content of between 7 and 30%, an overall lipid content of between 0.5 and 8%, a water content of between 40 and 70%, and a chemical value greater than 100, the said contents being expressed by weight per weight relative to the commercial product.

2. Food preparation according to claim 1, wherein the potato flake content is between 15 and 29%.

3. Food preparation according to claim 2, wherein the potato flake content is between 15 and 28%.

4. Preparation according to claim 1, wherein the milk protein content is between 10 and 28%.

5. Preparation according to claim 4, wherein the milk protein content is between 10 and 25%.

6. Preparation according to claim 1, wherein the egg powder or egg white content is between 2.5 and 9%.

7. Preparation according to claim 6, wherein the egg powder or egg white content is between 2.5 and 8%.

8. Preparation according to claim 1, having a protein content of 10 to 28%, a carbohydrate content of 7 to 28%, and a lipid content of 1 to 8%.

9. Preparation according to claim 8, having a protein content of 12 to 26%, a carbohydrate content of 10 to 27%, and a lipid content of 1.5 to 8%.

10. Preparation according to claim 1, containing a thickener, preferably chosen from gums and starches, the said thickener being present in a quantity of between 0 and 6%.

11. Preparation according to claim 10, containing a thickener, preferably chosen from gums and starches, the said thickener being present in a quantity of between 0.8 and 6%.

12. Preparation according to claim 11, containing a thickener, preferably chosen from gums and starches, the said thickener being present in a quantity of between 0.8 and 5.5%.

13. Preparation according to claim 1, wherein the milk proteins essentially consist of total milk protein.

14. Preparation according to claim 1, having a total calorific value before cooking of between 140 and 230 kcalories per 100 g.

15. Preparation according to claim 14, having a total calorific value before cooking of between 140 and 220 kcalories per 100 g.

16. Preparation according to claim 15, having a total calorific value before cooking of between 140 and 210 kcalories per 100 g.

17. Food preparation in the form of sticks, balls, patties or portions, which has not undergone any cooking or precooking treatment, designed for the preparation, by cooking, of products copying or resembling traditional potato-based products, obtained by shaping the food preparation in the form of a raw batter according to claim 1.

18. Method for making the food preparation in the form of a raw batter according to claim 1, comprising the following steps:
selecting the ingredients, weighing and measuring out,
intimately mixing the said ingredients, with or without premixing,
adding the liquids to the said mixture, with moderate and regular stirring, in particular in a kneader, in order to lead to the formation of a bound and homogeneous batter,
forming, in particular by laminating followed by cutting or forming into individualized portions such as chips, dauphine potatoes or minipatties,
optionally treating by means of refrigeration or deep-freezing.

19. Cooked food product, in the form of sticks, balls, patties or portions, copying or resembling traditional cooked potato-based products, obtained by forming and cooking the food preparations in the form of a raw batter according to claim 1.

20. Cooked food product according to claim 19, characterized in that it is obtained by cooking in the presence of fat, in a fryer-type cooking apparatus, and characterized in that it exhibits good homogeneity, an aerated texture inside and a crisp outer texture.

21. Cooked food product according to claim 20, having a protein content of 10 to 30%, a carbohydrate content of 10 to 30%, and a lipid content of 9 to 30% after cooking, the contents being expressed by weight per weight on the cooked product.

22. Cooked food product according to claim 20, having a water content of 15 to 50%.

23. Cooked food product according to claim 22, having a water content of 18 to 48%.

24. Cooked food product according to claim 23, having a water content of 20 to 48%.

25. Cooked food product according to claim 20, having a calorific value of 200 to 510 kcalories per 100 g.

26. Cooked food product according to claim 25, having a calorific value of 210 to 490 kcalories per 100 g.

27. Cooked food product according to claim 26, having a calorific value of 220 to 490 kcalories per 100 g.
